(19) United States
(12) Patent Application Publication
(10) Pub. No.: US 2016/0299020 A1
(43) Pub. Date: Oct. 13, 2016

(54) DEVICE FOR MEASURING PULLEY BELT SPAN

(71) Applicant: Caterpillar Inc., Peoria, IL (US)

(72) Inventor: Herchel R. Bryan, JR., Seguin, TX (US)

(73) Assignee: Caterpillar Inc., Peoria, IL (US)

(21) Appl. No.: 15/188,322

(22) Filed: Jun. 21, 2016

(51) Int. Cl. G01L 5/04

(52) U.S. Cl. CPC G01L 5/045

(57) ABSTRACT

A device for measuring span of a belt driveably engaging v-grooved pulleys is disclosed. The device includes a first arm having a first wedged end adapted to engage a first engaging portion. The first engaging portion is defined by a portion where the belt leaves a first pulley. The device includes a second arm having a second wedged end adapted to engage with a second engaging portion. The second engaging portion is defined by a portion where the belt leaves a second pulley. The device further includes an elongated portion coupled to the first arm by a first leg. The elongated portion has a scale indicative of a distance between the first wedged end and second wedge end. The device also includes a sliding portion coupled to the second arm and adapted to slidably receive the elongated portion of the first arm.

### TECHNICAL FIELD

The present disclosure relates to a device for measuring a distance between components of a machine and more particularly to a device for measuring a span of a belt engaging two pulleys.

### BACKGROUND

Different measuring devices and methods are employed on machines to measure dimensions of various machine components and to check operating parameters of the machines. For example, in a machine having a belt drive system for transmitting power from a first pulley to a second pulley connected by a belt, a proper tension of the belt drive system is to be maintained in order to ensure proper operation of the machine. The tension of the belt drive system may be determined based on a span of the belt. Therefore, the measurement of the span of the belt is critical when setting belt tension. However, it is difficult to accurately measure the span of the belt drive system after the belt is installed on the first pulley and the second pulley.

Various currently employed systems and methods of measuring the tension of the belt drive system rely on a distance between the first pulley and the second pulley, since accessibility to grooves of the pulleys in the belt drive systems is difficult. However, the distance between the first pulley and the second pulley may be different from the span of the belt. Therefore, various currently employed systems and methods of measuring the tension fail to accurately measure the tension of the belt drive system.

### SUMMARY OF THE DISCLOSURE

In one aspect of the present disclosure, a device for measuring a span of a belt driveably engaging v-grooved pulleys is disclosed. The device includes a first arm having a first wedged end adapted to engage a first engaging portion. The first engaging portion is defined by a portion where the belt leaves a first pulley. The device includes a second arm having a second wedged end adapted to engage with a second engaging portion. The second engaging portion is defined by a portion where the belt leaves a second pulley. The device further includes an elongated portion coupled to the first arm by a first leg. The elongated portion having a scale indicative of a distance between the first and second wedge end. The device also includes a sliding portion coupled to the second arm and adapted to slidably receive the elongated portion of the first arm.

Other features and aspects of this disclosure will be apparent from the following description and the accompanying drawings.

### BRIEF DESCRIPTION OF THE DRAWINGS

FIG. 1 is a perspective view of an exemplary engine with a belt drive system shown along a device for measuring a pulley belt span;

FIG. 2 is a perspective view of the device for measuring the pulley belt span, shown according to the concept of the present disclosure; and

FIG. 3 is a perspective view of the device for measuring the pulley belt span of the belt drive system, according to the concept of the present disclosure.

### DETAILED DESCRIPTION

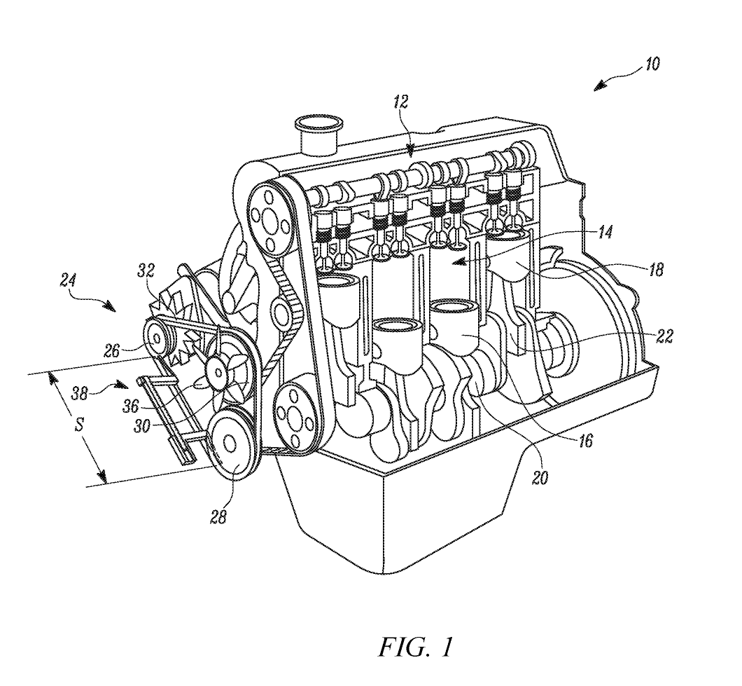

Referring now to FIG. 1, an exemplary engine 10 is shown. More specifically, the engine 10 is a multi cylinder IC engine. The engine 10 includes a cylinder head 12 and a cylinder block 14. The cylinder block 14 includes a plurality of cylinders 16. Each of the plurality of the cylinders 16 may house a piston 18 having a translatory movement within the cylinders 16. The piston 18 is coupled to a crankshaft 20 by a connecting rod 22. The connecting rod 22 converts the translator movement of the piston 18 to a rotary movement of the crankshaft 20. The crankshaft 20 is a belt drive system 24 for transmitting power.

As illustrated in FIG. 1, the belt drive system 24 includes a first pulley 26, a second pulley 28, and a third pulley 30 connected using a belt 32. The first pulley 26 is an alternator pulley. The second pulley 28 is a crankshaft pulley. The third pulley 30 is a radiator fan pulley. Specifically, the belt drive system 24 is used to transmit the power of the second pulley 28 to the first pulley 26 to operate an alternator 34. The belt drive system 24 is also used to transmit the power from the second pulley 28 to the third pulley 30 to operate a radiator fan 36. It may be contemplated that the belt drive system 24 can include different types of pulleys, known in the art. It may also be noted that the belt drive system 24 can have multiple pulleys based on application of the belt drive system 24.

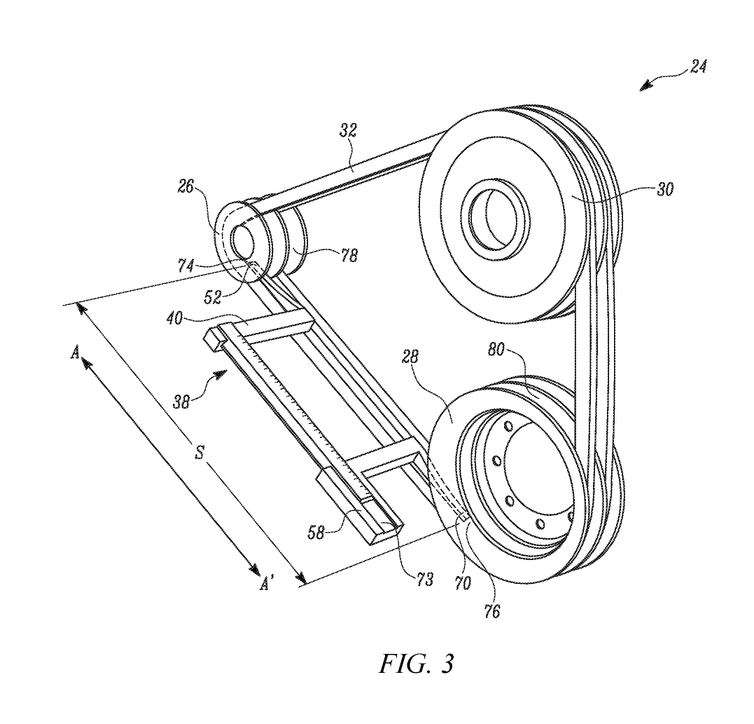

In one example, the belt drive system 24 is a v-belt system having v-grooved pulleys. The first pulley 26, the second pulley 28, and the third pulley 30 are v-grooved pulleys. The tension of the belt 32 depends on a pulley belt span ‘S’ of the belt 32 of the belt drive system 24. The pulley belt span ‘S’ hereinafter interchangeably referred to as span ‘S’. The span ‘S’ of the belt drive system 24 is a length of the belt 32 between the second pulley 28 and the first pulley 26, from a portion of the belt 32 at which the belt 32 leaves contact with the first pulley 26 and the second pulley 28. The portion at which the belt 32 leaves contact with the first pulley 26 is defined as the first engaging portion 74 (as shown in FIG. 3). The portion at which the belt 32 leaves contact with the second pulley 28 is defined as the second engaging portion 76 (as shown in FIG. 3). The distance between the first engaging portion 74 and the second engaging portion 76 is the span ‘S’ of the belt 32. In one embodiment, a device 38 is used to measure the span ‘S’ of the belt 32.

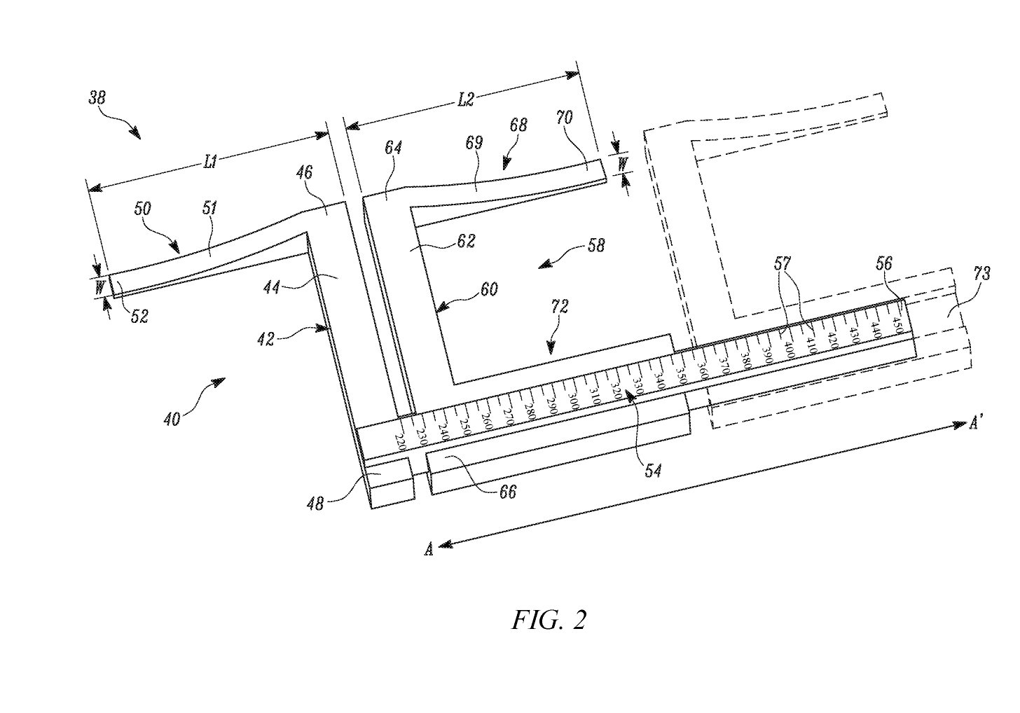

Referring to FIG. 2, a perspective view of the device 38 is shown. The device 38 includes a first member 40. The first member 40 includes a first body portion 42. In an example, as illustrated, the first body portion 42 has an L-shaped configuration. The first body portion 42 includes a first leg 44 and an elongated portion 54. The first leg 44 may have a rectangular cross-section. The first leg 44 has a first end 46 and a second end 48. The second end 48 is disposed opposite to the first end 46.

The first member 40 includes a first arm 50 extending outwardly from the first end 46 of the first leg 44 of the first member 40. The first arm 50 has a length ‘L1’. The first arm 50 has a first wedged end 52. The first arm 50 has a first tapered surface 51 extending from the first end 46 of the first leg 44 and tapering down towards the first wedged end 52 of the first arm 50. The first tapered surface 51 is provided to allow sufficient clearance between the second pulley 28 and the first arm 50. The first tapered surface 51 assists the first arm 50 to engage in a gap between the belt 32 and the second pulley 28 to an extent, which allows the first wedged end 52 to touch the first engaging portion 74. The opposite surface of the first tapered surface 51 is kept flat. A shape of cross section of the first arm 50 may vary with types of a groove 78 of the first pulley 26. The shape of the first arm 50 is determined such that it can be inserted inside the groove 78 of the first pulley 26. The first wedged end 52 of the first arm 50 is engaged with the first engaging portion 74 of the first pulley 26.

As mentioned earlier, the first body portion 42 includes the elongated portion 54. The elongated portion 54 extends outward from the second end 48 of the first leg 44. The elongated portion 54 is disposed parallel to the first arm 50. The elongated portion 54 includes a top surface 56 having a scale 57 defining a set of predefined markings. The set of predefined markings are spaced apart at a unit distance from each other.

The device 38 further includes a second member 58 associated with the first member 40. The second member 58 includes a second body portion 60. In an example, as illustrated, the second body portion 60 has an L-shaped configuration. The second body portion 60 includes a second leg 62 and a sliding portion 72. The second leg 62 has a first end 64 and a second end 66. The second member 58 includes a second arm 68 extending from the first end 64 of the second leg 62. The second arm 68 has a length ‘L2’.

The second arm 68 has a second wedged end 70. The second arm 68 includes a second tapered surface 69 extending from the first end 64 of the second leg 62 and tapering down towards the second wedged end 70 of the second arm 68. The second tapered surface 69 is provided to allow better clearance between the second pulley 28 and the second arm 68. The second tapered surface 69 assists the second arm 68 to engage in the gap between the belt 32 and the second pulley 28 to an extent, which allows the second wedged end 70 to get engaged at the second engaging portion 76. The opposite surface of the second tapered surface 69 is kept flat. A shape of cross section of the second arm 68 may vary with type of a groove 80 of the second pulley 28. The shape of the second arm 68 may be designed such that it can be inserted inside the groove 80 of the second pulley 28.

As mentioned earlier, the second body portion 60 includes the sliding portion 72. The sliding portion 72 extends outward from the second end 66 of the second leg 62, towards the second wedged end 70. The sliding portion 72 is disposed parallel to the second arm 68. The sliding portion 72 includes a groove 73 (shown in FIG. 3) extending throughout a length of the sliding portion 72. A cross-section of the groove 73 of the sliding portion 72 is formed to slidably receive the elongated portion 54 of the first member 40.

It may be contemplated that the length ‘L1’ of the first arm 50 and the length ‘L2’ of the second arm 68 may be different. However, the length ‘L1’ of the first arm 50 and length ‘L2’ of the second arm 68 must be kept sufficient enough to reach the first engaging portion 74 and the second engaging portion 76. Also, the first arm 50 and the second arm 68 have a width ‘W’. The width ‘W’ of the first arm 50 and the second arm 68 may be defined based on a width of the groove 78 in the first pulley 26 and the groove 80 of the second pulley 28 respectively, to accommodate within a space surrounding the first engaging portion 74 and the second engaging portion 76.

The second member 58 moves with respect to the first member 40 along a direction A-A′(illustrated in FIG. 2), when the elongated portion 54 of the first body portion 42 slides over the sliding portion 72 of the second body portion 60. The movement of the second member 58 along the direction A-A′ enables the first wedged end 52 and the second wedged end 70 of the device 38, to engage at the first engaging portion 74 and the second engaging portion 76 of the component. The span ‘S’ of the belt 32 of the belt drive system 24 is measured as a length between the first wedged end 52 and the second wedged end 70, when the first wedged end 52 is engaged with the first engaging portion 74 and the second wedged end 70 is engaged with the second engaging portion 76.

In one embodiment, the device 38 may be made of wood, metal, resin, plastic or any other material known in the art. It may be noted that various parts of the device 38, such as the first arm 50 and the second arm 68, may be connected detachably to the first leg 44 and the second leg 62, respectively.

Referring to FIG. 3, a schematic view of the device 38 used for measuring the span ‘S’ of the belt drive system 24 of FIG. 1 is illustrated. The first wedged end 52 and the second wedged end 70 of the device 38 engages the first engaging portion 74 and the second engaging portion 76, respectively. The scale 57 of the device 38 indicates a distance between the first engaging portion 74 and the second engaging portion 76. The predefined markings of the scale 57 starts by indicating a distance equivalent to a sum of the length ‘L1’ of the first arm 50 and the length of the second arm 68. In one example, the width ‘W’ the first arm 50 and the second arm 68 may be approximately equal to a width of the belt 32 installed in the belt drive system 24 and/or a width of the groove of the pulley of the belt drive system 24. It may be understood that the first wedged end 52 can also get engaged at the second engaging portion 76 and the second wedged end 70 can also get engaged at the first engaging portion 74, without limiting the scope of the present disclosure. Although the present disclosure discloses that the device 38 is used to measure the span ‘S’ of the belt 32 in the belt drive system 24, it may be contemplated that the device 38 may be used for measuring length of any component of the machine.

### INDUSTRIAL APPLICABILITY

The present disclosure relates to the device 38 for measuring the belt pulley span ‘S’ of the belt 32 of the belt drive system 24. The device 38 includes the first wedged end 52 and the second wedged end 70 for engaging the first engaging portion 74 and the second engaging portion 76 of the belt 32 for measuring the span ‘S’. In order to accurately measure the span ‘S’ of the belt 32, the first wedged end 52 of the device 38 engages with the groove 78 of the first pulley 26, where the belt 32 leaves the first pulley 26. Similarly, the second wedged end 70 of the device 38 which engages the groove 80 of the second pulley 28, where the belt 32 leaves the second pulley 28. The first wedged end 52 and the second wedged end 70 are moved back and forth for engaging with the first engaging portion 74 and the second engaging portion 76 using sliding movement of the first body portion 42 over the second body portion 60 of the device 38.

The device 38 provides a better accessibility to the groove of the pulleys, such as the first pulley 26, the second pulley 28, and the third pulley 30, which facilitates accurate measurement of the span ‘S’ of the belt 32 installed in the belt drive system 24. The accurate measurement of the span ‘S’ assists in setting the tension of the belt 32 with higher accuracy. The device 38 may be used to measure length of any other components of a machine, without limiting the scope of the present disclosure.

What is claimed is:

1. A device for measuring a span of a belt driveably engaging pulleys, the device comprising:
a first arm having a first wedged end adapted to engage a first engaging portion, wherein the first engaging portion is defined by a portion where the belt leaves a first pulley;
a second arm having a second wedged end adapted to engage with a second engaging portion, wherein the second engaging portion is defined by a portion where the belt leaves a second pulley;
an elongated portion coupled to the first arm by a first leg, the elongated portion having a scale indicative of a distance between the first and second wedge end; and
a sliding portion coupled to the second arm and adapted to slidably receive the elongated portion of the first arm.

2. The device of claim 1, wherein the elongated portion and the sliding portion are moved relative to each other such as to cause the first wedged end of the first arm to engage with the first engaging portion and the second wedged end of the second arm to engage with the second engaging portion, and wherein at this instance the scale indicates a distance between the first and second engaging portions.

3. The device of claim 1, wherein a width of the first wedged end and the second wedged end is less than a width of the groove of the first pulley and the second pulley respectively.

4. The device of claim 1, wherein a thickness of the first wedged end and the second wedge end is defined such as to accommodate within a space surrounding the first and second engaging portions.

5. The device of claim 1, wherein the first arm includes a first tapering surface extending from a first end of the first arm and tapering down towards the first wedged end.

6. The device of claim 1, wherein the second arm includes a second tapering surface extending from a first end of the second arm and tapering down towards the second wedged end.
